(19) United States
(12) Patent Application Publication
(10) Pub. No.: US 2006/0134323 A1
(43) Pub. Date: Jun. 22, 2006

(54) Fluoropolymer film made by printing

(76) Inventor: William George O'Brien, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/312,069

(22) Filed: Dec. 20, 2005

Related U.S. Application Data
(60) Provisional application No. 60/637,820, filed on Dec. 21, 2004.

(51) Int. Cl. B05D 5/06

(52) U.S. Cl. 427/162; 427/256

(57) ABSTRACT

Disclosed is a process for forming a patterned fluoropolymer film on a substrate by raised relief printing a fluoropolymer solution with a patterned raised relief printing plate, and drying the solvent from the solution to form the patterned fluoropolymer film. Such fluoropolymer films are useful as antireflective or hydrophobic layers on substrates used in optical displays.

### BACKGROUND OF THE INVENTION

1. Field of the Invention

The present invention relates to the field of forming a patterned fluoropolymer film by raised relief printing a fluoropolymer solution onto a substrate, and drying the solvent from the solution to form a patterned fluoropolymer film on the substrate.

2. Description of Related Art

Displays are widely used in various fields such as computer and television technologies. Displays such as liquid crystal displays (LCD's) and plasma displays (PDP's) make use of thin fluoropolymer films as antireflective coatings.

United States Published patent application 2002/34008 discloses a polarization film having an anti-glare layer and low reflection layer. The low reflection layer is provided on the anti-glare layer by means of a spin coater, roll coater or a printer.

United States Published patent application 2001/35929 discloses a film having a fluororesin low refractive index layer. The layer is disclosed as being formed by applying a coating solution by methods such as dip, air knife, curtain, roller, wire bar, gravure and extrusion coating.

U.S. Pat. No. 6,245,428 discloses an antireflection film having an outer fluoropolymer layer formed by reverse gravure coating.

PCT publication W003/36748 is directed to flexographic printing of catalyst ink on a membrane substrate to make electrodes. While this invention is useful in forming catalyst coated membranes, it is not directed to the formation of films, and in particular, films which have antireflective properties.

The use of amorphous fluoropolymer as an antireflective coating is known, as disclosed in U.S. Pat. Nos. 4,975,505 and 5,139,879. However, since such amorphous fluoropolymer is expensive, it would be desirable to use only that amount necessary to make a printed image on a film.

There exists a need for a process to coat an antireflective fluoropolymer film on a substrate which minimizes waste of the antireflective coating material.

### BRIEF SUMMARY OF THE INVENTION

The present invention overcomes the problems associated with the prior art by providing a process for printing a fluoropolymer from a solution to form a printed image which prints a fluoropolymer film on a substrate in the shape of the printed image. This process minimizes the amount of fluoropolymer wasted.

Therefore, in accordance with the present invention, there is provided a process for forming a patterned fluoropolymer film on a substrate, comprising (a) raised relief printing a fluoropolymer solution on a substrate with a patterned raised relief printing plate thereby forming a patterned fluoropolymer solution layer on said substrate, and (b) drying solvent from said patterned fluoropolymer solution layer thereby forming a patterned fluoropolymer film on said substrate

Amorphous fluoropolymer antireflective coatings can lack adequate resistance to surface abrasion and/or adhesion to substrates. In such instances, these shortcomings can be solved by using the present process in a stepwise fashion. Where adhesion of fluoropolymer to a substrate is inadequate, a thin (e.g., about 10 nm) adhesion promotor layer having acceptable adhesion to both substrate and fluoropolymer can first be printed on to an optically transparent substrate to form a adhesion promotor image on said substrate. An amorphous fluoropolymer layer (e.g., about 100 nm) can then be printed (on the adhesion promotor layer) from a solution to form a wet image, followed by drying. Likewise, where surface abrasion resistance of the fluoropolymer layer is inadequate, a thin (e.g., about 10 nm) of a hardcoat layer having acceptable surface abrasion resistance as well as adhesion to the fluoropolymer layer can be printed on the surface of the fluoropolymer layer. Where desirable, the liquid media may by blended and printed in a gradient fashion. For example, each of the adhesion promotor, fluoropolymer, and hardcoat liquid media may contain amounts of the other, so as to lead to a gradient change in refractive index from one material to the other in the resultant film.

Therefore, further in accordance with the present invention, there is provided a process for forming an antireflective film on a substrate comprising (a) flexographic printing an adhesion promotor layer onto an optically transparent substrate, (b) flexographic printing a solution of amorphous fluoropolymer onto said adhesion promotor layer to form a wet image on said adhesion promotor layer, (c) drying the solvent from said wet image to form an amorphous fluoropolymer film, and (d) flexographic printing a hardcoat layer on said amorphous fluoropolymer film, the thickness of the resultant antireflective-film being controlled and uniform so as to be about ¼ of the wavelength of incident light so as to provide anti-reflectivity of said incident light.

### BRIEF DESCRIPTION OF THE DRAWINGS

FIG. 1 is a perspective showing the use of flexographic proof press equipment to form fluoropolymer film.

FIG. 2 is a schematic view showing a continuous process in accordance with the present invention.

### DETAILED DESCRIPTION OF THE INVENTION

The present invention is directed to a process for forming a patterned fluoropolymer film on a display substrate. The process comprises raised relief printing a fluoropolymer solution on a substrate with a patterned raised relief printing plate thereby forming a patterned fluoropolymer solution layer on said substrate. The solvent is then dried from the patterned fluoropolymer solution layer thereby forming a patterned fluoropolymer film on the substrate.

Substrates of the present invention are optical articles such as display surfaces, optical lenses, windows, optical polarizers, optical filters, glossy prints and photographs, clear polymer films, and the like. The substrate may be either transparent or anti-glare. These optical articles are made of material such as acetylated cellulose (e.g., triacetyl cellulose (TAC), cellulose diacetate), polyester (e.g., polyethylene terephthalate (PET)), polycarbonate, polyacrylates (e.g., polymethylmethacrylate), polyvinyl alcohol, polystyrene, polyvinyl chloride, polyamide, glass, and the like. Preferred substrates are made of triacetyl cellulose, polyethylene terephthalate, polymethylmethacrylate and glass.

Raised relief printing as used herein refers to processes which employ any of a variety of types of pre-formed plates which have raised areas which define the shape or pattern to be printed on a substrate. In use in accordance with the present invention, the raised areas of the plate are contacted by and become coated with the fluoropolymer solution and then the raised areas are brought into contact with the substrate. After drying, the shape or pattern defined by the raised areas is thereby transferred to the substrate to form a fluoropolymer film. If desired, the relief printing is advantageously employed to form a film that is a build-up of multiple layers.

In accordance with a preferred form of the present invention, flexographic printing is the raised relief printing method employed. Flexographic printing is a printing technique used widely for packaging applications which employs elastomeric printing plates and is described in the Kirk-Othmer's Encyclopedia of Chemical Technology, 4th edition, 1996, John Wiley and Sons, New York, N.Y., volume 20, pages 62-128, especially pages 101-105. Such plates include sheet photopolymer plates, sheets made from liquid photopolymer and rubber printing plates. Especially useful are flexographic printing techniques which use photopolymer printing plates. The most preferred relief printing technique employs solid-sheet photopolymer plates such as the photopolymer flexographic printing plates sold by E.I. Du Pont de Nemours and Company of Wilmington, Del. under the trademark Cyrel®.

The flexographic method offers considerable benefits in cost, changeover, speed, ease of printing on thin extensible substrates and in the variety of films which can be printed. The printed area may be of virtually any shape or design, both regular or irregular, which can be transferred to the plate. Possible shapes include circles, ovals, polygons, and polygon having rounded corners. The shape may also be a pattern and may be intricate if desired.

Multiple applications of the same or different coatings to the same area on a substrate are easily accomplished using flexographic printing. In existing uses of flexography, it is common to apply multiple colors of ink in close registration and these techniques are well-suited to the printing of antireflective fluoropolymer films having overlying multiple layers. The composition and the amount of coating applied per application may be varied. The amount of coating applied at each pass may be varied across the coated area, i.e., length and/or width. Such variation need not be monotonic or continuous. The precision of flexographic printing has the further advantage of being very economical in the use of coating fluoropolymer solution, which is particularly important for expensive fluoropolymers.

In the preferred flexographic printing method in accordance with the invention using solid-sheet photopolymer flexographic plates, commercially-available plates such those sold under the trademark Cyrel® are well adapted for use in the process. Cyrel® plates are thick slabs of photopolymer uniformly deposited/bonded to 5 to 8 mil poly(ethylene terephthalate) (PET), then capped with a thin easy-release PET coversheet. The photopolymer itself is a miscible mixture of about 65% acrylic polymer(s), 30% acrylic monomer(s), 5% dyes, initiators, and inhibitors. U.S. Pat. Nos. 4,323,636 and 4,323,637 disclose photopolymer plates of this type.

Negatives having images to create the raised areas on the plate can be designed by any suitable method and the creation of negatives electronically has been found to be especially useful. Upon UV exposure through the negative, monomer polymerization occurs in select areas. Following removal of the PET coversheet, unexposed, non-polymerized material may be removed by a variety of methods. The unexposed areas may be simply washed away by the action of a spray developer. Alternatively, the non-polymerized monomer may be liquefied by heating and then removed with an absorbent wipe material. A compressible photopolymer relief surface, made to photographic resolution is thus created. This relief surface serves to transfer fluoropolymer solution from a bulk applicator to a print applicator or to the substrate surface itself. Formation of an patterned fluoropolymer solution layer occurs by simple wetting coupled with mechanical compression of the elastomeric plate.

When rubber printing plates are employed, the pattern may be generated by known techniques including molding said rubber plate in the desired pattern or by laser ablation to yield the desired shape or pattern.

The process of the present invention involves a fluoropolymer solution comprising fluoropolymer and solvent which is adapted for use in the raised relief printing process. The fluoropolymer is preferably amorphous, so that the fluoropolymer is soluble at an appreciable concentration in solvent and so that the resultant fluoropolymer film is transparent. Fluoropolymers of the present invention include copolymers, amorphous preferably, of at least one monomer selected from: a) chlorotrifluoroethylene, b) vinylidene fluoride, c) hexafluoropropylene, d) trifluoroethylene, e) perfluoro(alkyl vinyl ethers) of the formula CF₂=CFOR_{F}, where R_{F} is a normal perfluoroalkyl radical having 1-5 carbon atoms, f) fluorovinyl ethers of the formula CF₂=CFOQZ, where Q is a perfluorinated alkylene radical containing 0-5 ether oxygen atoms, wherein the sum of the C and O atoms in Q is 2 to 10, and Z is a group selected from —COOR, —SO₂F, —CN, —COF and —OCH₃, where R is a C₁-C₄ alkyl radical, g) vinyl fluoride, h) (perfluoroalkyl)ethylenes of the formula R_{f}CH=CH₂, where R_{f} is a C₁-C₈ normal perfluoroalkyl radical, i) perfluoro-2-methylene-4-methyl-1,3-dioxolane (PMD), j) perfluoro-2,2-di-loweralkyl-1,3-dioxoles, for example, perfluoro-2,2-dimethyl-1,3-dioxole (PDD), and k) tetrafluoroethylene. Preferred are amorphous fluoropolymers comprising repeating units arising from tetrafluoroethylene and 30-99 mole % of at least one comonomer selected from the aforemention a) through j). Examples of amorphous fluoropolymers that are commercially available include Teflon® AF from DuPont® and Cytop™ from Asahi Glass Co., Ltd., Tokyo, Japan. The amorphous character of the copolymers make them fabricable to optically clear films.

The present process may further comprise raised relief printing of an adhesion promotor on the substrate with a patterned raised relief printing plate prior to the steps forming the patterned fluoropolymer film on the substrate. Adhesion promotors are silane-based compounds well known for improving the adhesion between organic resins and substrates. These silane adhesion promoters have two types of substituents, one is an organofunctional radical bonded directly to the silicon atom and the other is an organic substituent bound through oxygen such as C₁-C₄-alkoxy or C₂-C₄ acetoxy. Preferably, the organofunctional silane has three C₁-C₄ alkoxy groups and, most preferably, they are ethoxy or methoxy. The organofunctional groups are typically electrophilic. Commercially available silane adhesion promoters have acryloxyorgano-, aminoorgano-, ureidoorgano- or glycidoxyorgano-functional groups. Acryloxyorganotri(C₁-C₄)alkoxysilanes and aminoorganotri(C₁-C₄)aIkoxysilanes are preferred, examples of which include acryloxypropyltrimethoxysilane, gamma-aminopropyltrimethoxysilane, N-beta-(aminoethyl)-gamma-aminopropyltriethoxysilane and N-beta-(aminoethyl)-N-beta-(aminoethyl)-gamma-aminopropyltrimethoxysilane.

The present process may further comprise raised relief printing of a conventional hardcoat on the patterned fluoropolymer film. Typically hardcoat compositions are formed from acrylate or fluoroacrylate polymers that, when cured, are resistant to abrasive forces. Thus, the subsequently formed hardcoat layer will help prevent abrasion of the fluoropolymer film. Conventional hardcoat film has been produced by coating a surface with a highly scratch-resistant resin, generally a thermosetting resin or an ionizing radiation curing resin, such as an ultraviolet curing resin. Further, in the conventional hardcoat films, an attempt has been made to add an inorganic filler to a film-forming organic component having a polymerizable functional group to enhance the hardness. A wide variety of hardcoat materials may be used in hardcoat layer herein. The hardcoat layer preferably contains nanometer-sized inorganic oxide particles dispersed in a binder matrix, also referred to as ceramers. The hardcoat layer may be formed by coating a curable liquid ceramer composition onto the substrate and curing the composition in situ to form a hardened film.

A variety of inorganic oxide particles may be used in hardcoat layer. The particles preferably are substantially spherical in shape and relatively uniform in size. The particles can have a substantially monodisperse size distribution or a polymodal distribution obtained by blending two or more substantially monodisperse distributions. Preferably the inorganic oxide particles are and remain substantially non-aggregated (substantially discrete), as aggregation can result in precipitation of the inorganic oxide particles or gelation of the hardcoat. Preferably the inorganic oxide particles are colloidal in size, that is, they preferably have an average particle diameter of about 0.001 to about 0.2 micrometers, more preferably less than about 0.05 micrometers, and most preferably less than about 0.03 micrometers. These size ranges facilitate dispersion of the inorganic oxide particles into the binder resin and provide ceramers with desirable surface properties and optical clarity. Preferred inorganic oxide particles include colloidal silica, colloidal titania, colloidal alumina, colloidal zirconia, colloidal vanadia, colloidal chromia, colloidal iron oxide, colloidal antimony oxide, colloidal tin oxide, and mixtures thereof. Silica is a particularly preferred inorganic particle. The hardcoat layer preferably contains about 10 to about 50 parts by weight, and more preferably about 25 to about 40 parts by weight of inorganic oxide particles per 100 parts by weight of a binder polymer. More preferably the hardcoat is derived from a ceramer composition containing about 15% to about 40% acrylate functionalized colloidal silica, and most preferably about 15% to about 35% acrylate functionalized colloidal silica. A variety of binder polymers can be employed in the hardcoat layer. Preferably the binder is derived from a free-radically polymerizable precursor that can be photocured once the hardcoat composition has been coated upon the substrate. Binder precursors such as the protic group-substituted esters or amides of an acrylic acid described in U.S. Pat. No. 5,104,929 (Bilkadi '929), or the ethylenically-unsaturated monomers described in Bilkadi et al. '050, are especially preferred.

Preferably the inorganic particles, binder and any other ingredients in the hardcoat layer are chosen so that the cured hardcoat has a refractive index close to that of the substrate. This can help reduce the likelihood of Moire patterns or other visible interference fringes.

The hardcoat layer can be crosslinked with various agents to increase the internal cohesive strength or durability of the hardcoat. Preferred crosslinking agents have a relatively large number of available functional groups, and include tri and tetra-acrylates, such as pentaerythritol triacrylate and pentaerythritol tetraacrylate. When used, the crosslinking agent preferably is less than about 60 parts, and more preferably about 30 to about 50 parts by weight per 100 parts by weight of the binder.

Those skilled in the art will also appreciate that the hardcoat layer can contain other optional adjuvants, such as surface treatment agents, surfactants, antistatic agents (e.g., conductive polymers), leveling agents, initiators (e.g., photoinitiators), photosensitizers, UV absorbers, stabilizers, antioxidants, fillers, lubricants, pigments, dyes, plasticizers, suspending agents and the like.

After coating, the solvent, if any, is flashed off with heat, vacuum, and/or the like. The coated ceramer composition is then cured by irradiation with a suitable form of energy, such as heat energy, visible light, ultraviolet light or electron beam radiation. Irradiating with ultraviolet light in ambient conditions is presently preferred due to the relative low cost and speed of this curing technique.

The solvent for the fluoropolymer solution is one selected to be compatible with the process. It is advantageous for the solvent to have a sufficiently low boiling point that rapid drying of films is possible under the process conditions employed, provided however, that the fluoropolymer solution cannot dry so fast that it dries on the relief printing plate before transfer to the substrate.

A wide variety of fluorinated solvents or mixtures thereof can serve as suitable solvent for the fluoropolymer solution. Suitable solvents are those capable of forming about a 5 weight % or greater solution of fluoropolymer in solvent. Fluorinated solvents include chlorofluorocarbons (e.g., 1,1,2-trichloro-1,2,2-trifluoroethane (CFC-113)), hydrofluorocarbons (e.g., 1,1,1,2,2,3,4,5,5,5-decafluoropentane (e.g., HFC-43-10mee)), perfluoroalkanes (e.g., perfluorooctane), perfluoroaromatics (e.g., hexafluorobenzene, octafluoronaphthalene), and fluorinated ethers (e.g., cyclic perfluoroether Fluorinert™ FC-75, available from 3M, C₄F₉OC₂H₅ and C₃F₇OCF(CF₃)CF₂OCHFCF₃).

The amount of solvent in the fluoropolymer solution will vary with the solvent, the fluoropolymer, the type of raised relief printing equipment employed (e.g., the anilox roll volume and line screen used and the number of transfer rolls, if any), the desired fluoropolymer film thickness, process and coating line speeds, etc. The amount of liquid employed is highly dependent on viscosity of the composition. Establishing appropriate raised relief printing parameters is within the skill of one of ordinary skill in this field.

Handling properties of the coating composition, e.g. drying performance, can be modified by the inclusion of compatible cosolvents which will speed up or slow down the drying rate. For examples, hydrocarbons, alcohols as well as fluoroethers and fluoroalcohols may be employed as such cosolvents.

In accordance with the present invention, the thickness of the resultant dried film is uniform and is controlled so as to be about one-quarter of the wavelength of incident light so as to provide anti-reflectivity of the incident light. Utilization of the fluoropolymer solution coating technique in accordance with the process of the present invention can produce a wide variety of printed fluoropolymer films which can be of essentially any thickness ranging from very thick, e.g., 1 μm or more to very thin, e.g., about 20 nm to 200 nm. The thickness of the film is about 1,000 nm or less. If the film is an antireflective film, the film preferably has a thickness of from about 80 nm to about 120 nm.

Flexographic printing allows for control of the variance of thickness of the fluoropolymer film down to about ±5 nm, and below. This full range of thicknesses can be produced without evidence of cracking, loss of adhesion, or other inhomogeneities. Thick layers, or complicated multi-layer structures, can be achieved by utilizing the very precise pattern registration available using flexographic printing technology to provide multiple layers deposited onto the same area so that the desired ultimate thickness can be obtained. On the other hand, only a few layers or a single layer can be used to produce very thin films. Typically, 20 nm to 120 nm thick fluoropolymer films are produced with each printing and drying cycle.

The multilayer structures mentioned above permit the coating to vary in composition, enabling enhanced adhesion

Composition may also be varied over the length and width of the fluoropolymer film coated area by controlling the amount applied as a function of the distance from the center of the application area as well as by changes in coating applied per pass. By varying coating composition or plate image characteristics, the gradient of optical activity can be made gradual.

While the process of the invention can be performed to make discrete pieces of substrate containing antireflective fluoropolymer film, the invention is advantageously carried out by performing the raised relief printing in a continuous fashion using roll stock substrate with single or multiple coating and drying stations similar to those used in the color print industry.

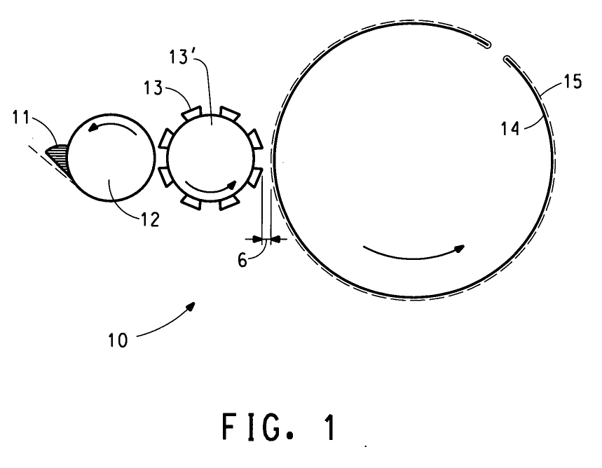

FIG. 1 shows the use of flexographic proof press equipment to form a patterned fluoropolymer film on a substrate in accordance with the present invention. As shown in FIG. 1, in coating station 10, the fluoropolymer solution 11 is picked up by the anilox roll 12. An anilox roll is a standardized tool of the printing industry comprising a precision engraved cellular surfaced roll which draws out a uniform fluoropolymer solution film from the reservoir. The fluoropolymer solution thickness is controlled by the specific anilox cell geometry chosen. A portion of this fluoropolymer solution film is transferred to a relief printing plate 13 having a plate impression 6, such as a Cyrel® flexographic printing plate, positioned on a drum 13′. A substrate 15, such as a triacetyl cellulose (TAC) film, positioned on a rotating drum 14 picks up the fluoropolymer solution 11 from the relief printing plate 13, to form a relief image on the substrate. The dried relief image serves as an antireflective film on the substrate. This can be repeated the desired number of passes to produce the desired thickness of the fluoropolymer film.

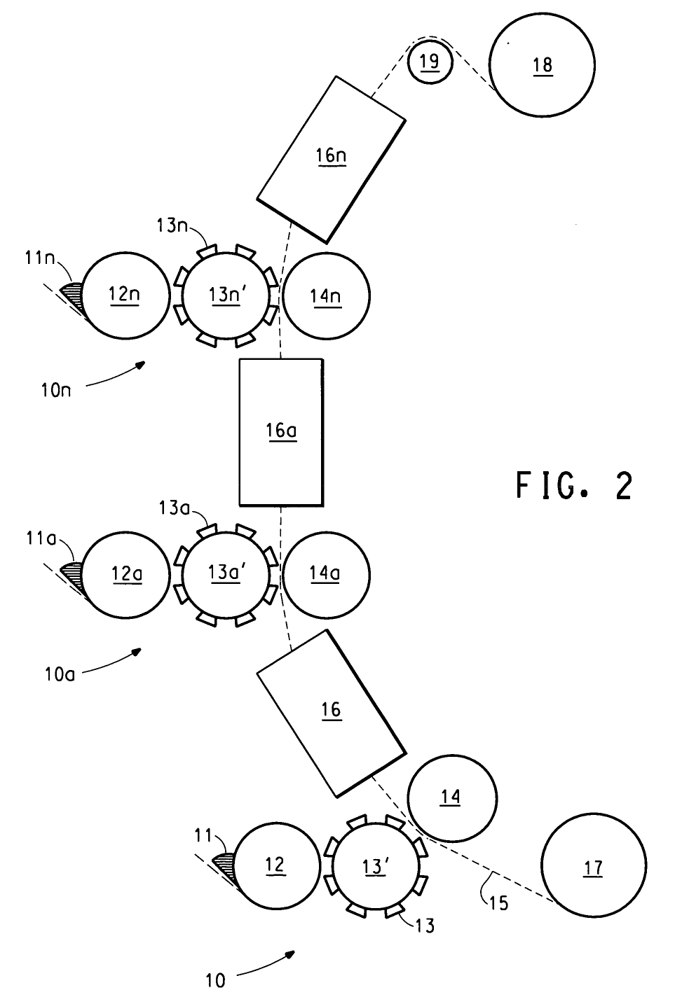

FIG. 2 shows a continuous process employing rolls stock utilizing three discrete printing stations to form multiple films in a continuous fashion. As shown in FIG. 2, the substrate to be coated is unwound from roll 17, past the coating station 10 shown in FIG. 1 and a drying station 16. Additional coatings and drying can be accomplished as shown in coating stations 10a to 10n and drying stations 16a and 16n, on to the coated and dried substrate from coating station 10. Any number of coating stations may be present between 10a and 10n depending of the desired thickness of the film to be formed or different coating compositions may be applied at each coating station to form an antireflective film comprising multiple layers on the surface of the substrate. In coating stations 10a and 10n respectively, compositions 11a and 11n are picked up by the anilox rolls 12a and 12n and transferred to relief printing plates 13a and 13n, positioned on a drum 13a′ and 13n′. The coated and dried substrate from coating station 10n is then wound onto roll 18 past idler roll 19 as shown. The coating compositions at the three stations may be the same or different (e.g., adhesion promotor, fluoropolymer solution, hardcoat).

The direct product of the process is a length of substrate with patterned fluoropolymer film formed on it. The product can be stored in roll form which facilitate handling and/or subsequent processing operation.

In accordance with the present invention, the fluoropolymer film image which is formed may consist of a succession of images spaced apart from one another. In this case, the printing is carried out continuously to produce the succession of images. The images are spaced apart in the direction of the printing.

### EXAMPLES

### Example 1

A GMS Proofing Press (Global Media Solutions Ltd., Manchester, England) equipped with a 200 lpi anilox roll and a Cyrel® PLB45 (E. I. du Pont de Nemours & Co., Wilmington, Del. USA) printing plate imaged & cured to give a 5 cm×5 cm printing surface was used to deposit multiple layers of Teflon® AF1601 (E. I. du Pont de Nemours & Co., Wilmington, Del., USA, amorphous copolymer of tetrafluoroethylene and perfluoro-2,2-dimethyl-1,3-dioxole) from solutions of 6.0, 3.0 and 1.5 wt % Teflon® AF1601 in Fluorinert® FC-40 fluoro-solvent (3M, St. Paul, Minn., USA) on high clarity 200D Mylar® (E. I. du Pont de Nemours & Co., Wilmington, Del., USA) at about 240 ft/min for proofer drum revolution. Wet layers were transferred in the sharp exact pattern of the printing plate and dried evenly. Measured Teflon® AF1601 fluoropolymer film thickness for a double impression print/dry, print/dry process were 1000 nm, 500 nm and 200 nm for the above 6.0, 3.0 and 1.5 wt % Teflon® AF1601 solutions respectively. Thicknesses were measured by a Filmetrics F-20 (Filmetrics Inc., San Diego, Calif., USA) reflectance spectra analyzer. Films produced were visually uniform and continuous.

### Example 2

The GMS press of Example 1 with a finer 440 lpi anilox roll and same Cyrel® PLB45 plate and 3.0 to 4.0 wt % Teflon® AF1601 solutions in a variety of fluorosolvents (FC-40, perfluorooctylethylene (PFOE), perfluorooctane (PFO)) was used to create single impression thickness fluoropolymer films in the range of 70 nm to 120 nm thickness on 200D Mylar. Thicknesses were measured by a Filmetrics F-20 reflectance spectra analyzer. Films produced were visually uniform and continuous.

### Example 3

A Mark-Andy printing press (12″ Width, Mark-Andy, Inc., St. Louis, Mo., USA) was equipped with a 440 lpi anilox and a 3.5″×7″ imaged & cured Cyrel® PLB45 plate. A Teflon® SF50 (E. I. du Pont de Nemours & Co., Wilmington, Del, USA, amorphous equimolar copolymer of tetrafluoroethylene and hexafluoropropylene) solution at 1.25 wt % in an 85/15 by weight solvent mix of PFO/PFOE was continuously deposited on a 500A Mylar (E. I. du Pont de Nemours & Co., Wilmington, Del., USA) substrate at 28, 120 & 150 ft/min line speeds producing ultra-thin SF50 fluoropolymer films on the order of 20 nm to 30 nm thickness as estimated from SEM cross-section.

What is claimed is:

1. A process for forming a patterned fluoropolymer film on a substrate, comprising:
(a) raised relief printing a fluoropolymer solution on a substrate with a patterned raised relief printing plate thereby forming a patterned fluoropolymer solution layer on said substrate, said fluoropolymer solution comprising fluoropolymer and solvent, and;
(b) drying said solvent from said patterned fluoropolymer solution layer thereby forming a patterned fluoropolymer film on said substrate.

2. The process of claim 1 further comprising raised relief printing an adhesion promotor on said substrate with a patterned raised relief printing plate prior to steps (a) and (b), thereby forming a patterned adhesion promotor layer on said substrate.

3. The process of claim 1 further comprising raised relief printing a hardcoat layer on said patterned fluoropolymer film.

4. The process of claims 1, 2 or 3 wherein said raised relief printing is flexographic printing.

5. The process of claim 1 wherein steps (a) and (b) are repeated thereby increasing the thickness of said film.

6. The process of claim 1 wherein said fluoropolymer is amorphous and said film is transparent.

7. The process of claim 1 wherein said substrate is selected from the group consisting of: acetylated cellulose, polyester, polycarbonate, polyacrylate, polyvinyl alcohol, polystyrene, polyamide, polyvinyl chloride and glass.

8. The process of claim 1 wherein said substrate is selected from the group consisting of: triacetyl cellulose, polyethylene terephthalate, polymethylmethacrylate and glass.

9. The process of claim 1 wherein said substrate is an electrowetting display component.

10. The process of claim 1 wherein said fluoropolymer is an amorphous copolymer comprising at least one monomer selected from the group consisting of: a) chlorotrifluoroethylene, b) vinylidene fluoride, c) hexafluoropropylene, d) trifluoroethylene, e) perfluoro(alkyl vinyl ethers) of the formula CF₂=CFOR_{F}, where R_{F} is a normal perfluoroalkyl radical having 1-5 carbon atoms, f) fluorovinyl ethers of the formula CF₂=CFOQZ, where Q is a perfluorinated alkylene radical containing 0-5 ether oxygen atoms, wherein the sum of the C and O atoms in Q is 2 to 10, and Z is —COOR, —SO₂F, —CN, —COF or —OCH₃, where R is a C₁-C₄ alkyl radical, g) vinyl fluoride, h) (perfluoroalkyl)ethylene of the formula R_{f}CH=CH₂, where R_{f} is a C₁-C₈ normal perfluoroalkyl radical, i) perfluoro-2-methylene-4-methyl-1,3-dioxolane, j) perfluoro-2,2-dimethyl-1,3-dioxole and k) tetrafluoroethylene.

11. The process of claim 1 wherein said fluoropolymer is an amorphous copolymer of tetrafluoroethylene and perfluoro-2,2-dimethyl-1,3-dioxole.

12. The process of claim 1 wherein the thickness of said film is about 1,000 nm or less.

13. The process of claim 1 wherein the thickness of said film is from about 20 nm to about 200 nm.

14. The process of claim 1 wherein said film is an antireflective film having a thickness of from about 80 nm to about 120 nm.

15. The process of claim 1 wherein the variance in thickness of said patterned fluoropolymer film is about ±5 nm.

16. A process for forming an antireflective film on a substrate comprising:
(a) flexographic printing a solution of amorphous fluoropolymer onto an optically transparent substrate to form a wet image on said substrate,
(b) drying the solvent from said wet image to form a fluoropolymer film, the thickness of said fluoropoymer film being controlled and uniform so as to be about ¼ of the wavelength of incident light so as to provide anti-reflectivity of said incident light.

17. A process for forming an antireflective film on a substrate comprising:
(a) flexographic printing an adhesion promotor layer onto an optically transparent substrate,
(b) flexographic printing a solution of amorphous fluoropolymer onto said adhesion promotor layer to form a wet image on said adhesion promotor layer,
(c) drying the solvent from said wet image to form an amorphous fluoropolymer film, and (d) flexographic printing a hardcoat layer on said amorphous fluoropolymer film, the thickness of the resultant antireflective-film being controlled and uniform so as to be about ¼ of the wavelength of incident light so as to provide anti-reflectivity of said incident light.
